(19) United States
(12) Patent Application Publication
(10) Pub. No.: US 2015/0217725 A1
(43) Pub. Date: Aug. 6, 2015

(54) TRAILER ANTI-THEFT AND WHEEL PROTECTION SYSTEM

(71) Applicant: Gene Gabaldon, Chandler, AZ (US)

(72) Inventor: Gene Gabaldon, Chandler, AZ (US)

(21) Appl. No.: 14/173,574

(22) Filed: Feb. 5, 2014

(51) Int. Cl. B60R 25/09

(52) U.S. Cl. CPC B60R 25/09

(57) ABSTRACT

The disclosure relates to a wheel locking system comprising a pair of wheel attaching devices, each mounted to one of two trailer wheels arranged in tandem. Each of the wheel attaching devices comprises a first portion attachable to a wheel, and a second portion attachable to the first portion and having an outwardly extending piece. The wheel locking system further includes a plate fitted under a fender (or a plate-fender combination), the plate including a pair of openings accepting the outwardly extending pieces and allowing end portions of the outwardly extending pieces to protrude. The protruding end portions of the outwardly extending pieces include lock holes for which padlocks can be placed. In such a manner, when locked, the wheel locking devices are secured to the plate and prevent the wheels from rotating while providing the wheels with protection from the elements.

### BACKGROUND OF THE INVENTION

1. Field of the Invention

The present invention relates to a trailer anti-theft and wheel protection system.

2. Description of the Related Art

Many businesses and individuals use utility trailers to carry tools, material and equipment to jobsites and elsewhere. Other types of trailers, such as recreational trailers, boat trailers, horse trailers, etc., are also quite popular. Sometimes these trailers are left unattended for lengthy periods. During these storage periods, the trailer's wheels, particularly the tires, can become fragile from the outdoor elements. Worse, unattended trailers are subject to theft which has become commonplace. Where the trailers are enclosed and the doors locked, there is some degree of security. However, locks can often be cut with bolt cutters or pried open. More troubling, thieves can simply attach the trailer to a car and drive off with it. Later, the thieves can empty out the contents of the trailer.

To reduce the chances of trailer theft, various anti-theft devices have been developed. Such conventional anti-theft devices include wheel locks. The most effective are known as “wheel claws” which clamp to both sides of a wheel. Wheel claws deter some would-be thieves, but are actually relatively easy to defeat. For instance, with many such devices, it is possible to gain access to the lug nuts to remove the wheel. The wheel can then be replaced with a spare, and the trailer driven off. Moreover, even where the lug nuts are blocked, the device can be removed without difficulty. And even when conventional anti-theft devices are somewhat effective for anti-theft purposes, they do not afford protection to the wheels or tires from outdoor elements.

### SUMMARY OF THE INVENTION

The disclosure relates to a wheel locking system comprising a pair of wheel attaching devices, each mounted to one of two trailer wheels arranged in tandem. The first wheel attaching device and the second wheel attaching device have substantially the same structure, and each of the wheel attaching devices comprises a first portion attachable to a wheel, and a second portion attachable to the first portion and having an outwardly extending piece. The wheel locking system further includes a plate fitted under a fender (or a plate-fender combination) including a pair of openings accepting the outwardly extending pieces and allowing end portions of the outwardly extending pieces to protrude. The protruding end portions of the outwardly extending pieces include lock holes for which padlocks can be placed. In such a manner, when locked, the wheel locking devices are secured to the plate and prevent the wheels from rotating while providing the wheels with protection from the elements.

### BRIEF DESCRIPTION OF THE DRAWINGS

FIG. 1 illustrates an exemplary wheel attaching device, according to an embodiment of the present invention;

FIG. 2 illustrates the wheel attaching device of FIG. 1 in an unassembled form;

FIG. 3 illustrates two trailer wheels arranged in tandem;

FIG. 4 illustrates wheel attaching devices attached to each of the trailer wheels;

FIG. 5 illustrates a fuller view of an enclosed utility trailer having the wheel attaching devices attached to the trailer wheels;

FIG. 6A illustrates an exemplary plate attached under the fender and attached to the trailer wheels, according to an embodiment of the present invention;

FIG. 6B illustrates an exemplary plate and fender combination attached to the trailer wheels, according to another embodiment of the present invention;

FIG. 7 illustrates a close-up view highlighting an exemplary opening in the plate, according to an embodiment of the present invention;

FIG. 8 illustrates a close-up view showing an exemplary padlock attached to an outwardly extending piece of a wheel locking device, according to an embodiment of the present invention; and

FIGS. 9A and 9B illustrate views of an exemplary padlock suitable for use to lock a wheel locking device to the metal plate.

### DETAILED DESCRIPTION OF THE INVENTION

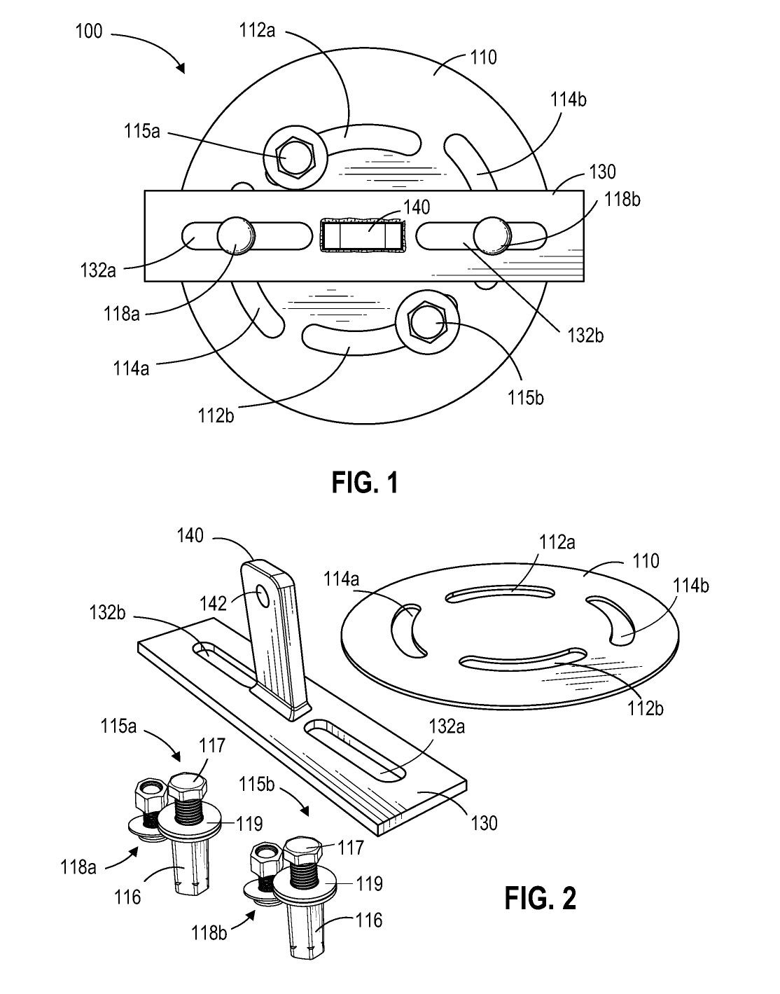

Referring to FIG. 1, an exemplary wheel attaching device 100, according to an embodiment of the present invention, is shown. The wheel attaching device 100 comprises a first wheel attaching device portion 110 and a second wheel attaching device portion 130. In the illustrated embodiment, the first wheel attaching device portion 110 is disk shaped, but the first wheel attaching device portion 100 could have another suitable shape, e.g., oval, square, cylindrical. To ensure that the wheel attaching device 100 is difficult to defeat, the first wheel attaching device portion 110 and the second wheel attaching device portion 130 are made of a strong material, e.g., hardened steel.

As shown, the first wheel attaching device portion 110 has a first pair of curved grooves 112a, 112b and a second pair of curved grooves 114a, 114b. A selected one of these pairs of grooves accommodates wheel fastening bolts 115a, 115b, which can be lug nut extender bolts attached to respective lug nuts of a trailer wheel, thereby allowing attachment of the first wheel attaching device portion 110 to the trailer wheel. FIG. 2 illustrates the wheel attaching device 100 in an unassembled form, and provides a perspective view of the component parts. As illustrated, the wheel fastening bolts 115a, 115b are lug nut extenders including bolt 117 screwed into base 116 (which itself has an inner threaded portion that can screw onto a lug bolt). Washers 119 can also be used. It is to be understood that the fastening bolts used can be different from those illustrated.

The distance from the first pair of curved grooves 112a, 112b to the central axis of the trailer wheel upon which the wheel attaching device 100 is mounted is different from the distance from the second pair of curved grooves 114a, 114b to the central axis. For instance, the first pair of grooves 112a, 112b are formed to allow for attachment to wheels which have lug nuts at about 4.5 inches from center, while the second pair of curved grooves 114a, 114b are formed to allow for attachment to wheels which have lug nuts at about 5.5 inches from center. Still other placements of the grooves can be provided, such as a groove for wheels having lug nuts at about 6.5 inches from center. The first pair of curved grooves 112a, 112b and the second pair of curved grooves 114a, 114b can be formed by molding the first wheel attaching device portion 110 with these features, machining the grooves into the first wheel attaching device portion 110, or by another suitable process.

Importantly, the selected pair of curved grooves (112a, 112b or 114a, 114b) have the requisite shape and length characteristics to accommodate at least two lug nuts of the trailer wheel no matter their orientation along the wheel. That is, because the trailer can be parked with lug nuts appearing anywhere around the wheel, the grooves are formed to accommodate any lug nut orientation but still allow at least two of the lug nuts to fit into the grooves. In an embodiment, the grooves are each about 4.5 inches in length, about ⅝th inches in width, and are curved about a path where the lug nuts could land no matter the terminal position of the trailer wheel.

As shown, the second wheel attaching device portion 130 has a pair of longitudinal grooves 132a, 132b. Fasteners 118a, 118b are placed through the longitudinal grooves 132a, 132b and the pair of grooves (112a, 112b or 114a, 114b) not selected for attachment to the lug nuts. In such a manner, the first wheel attaching device portion 110 can be attached to the second wheel attaching device portion 130. FIG. 2 shows that the fasteners 118a, 118b are a nut and bolt combination. In the example assembly shown in FIG. 1, the pair of grooves 112a, 112b are selected to accommodate fasteners 115a, 115b (to the lug nuts) and the pair of grooves 114a, 114b are selected to accommodate the fasteners 118a, 118b.

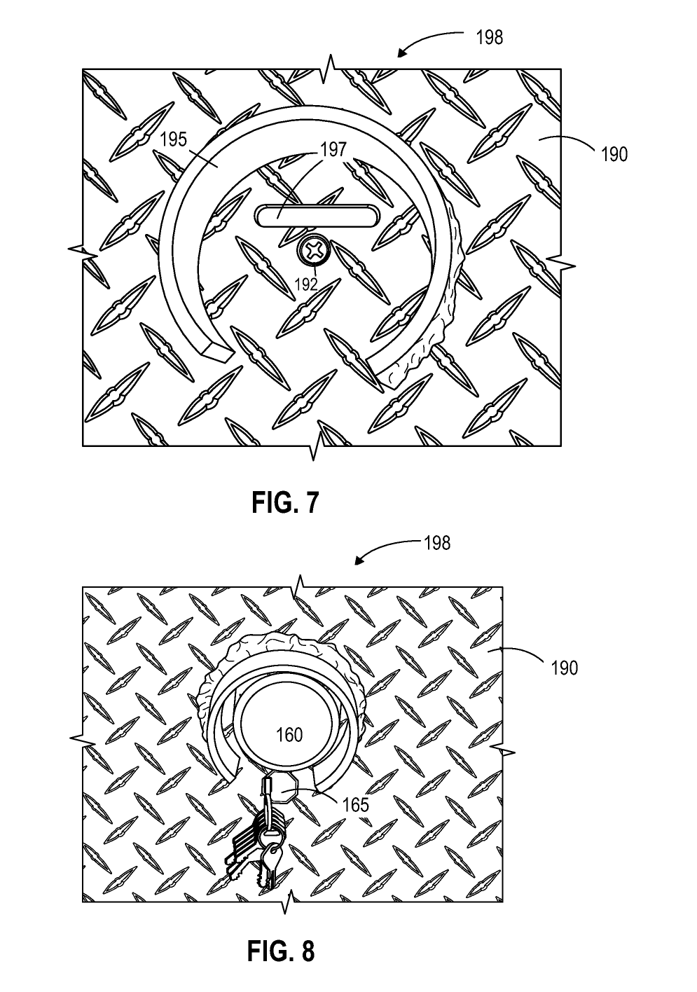

Additionally, the second wheel attaching device portion 130 has an outwardly extending piece 140. As shown in FIG. 2, the outwardly extending piece 140 extends from a base 130 which includes the pair of longitudinal grooves 132a, 132b which are for horizontal adjustment to fit into the predetermined accommodating holes (as shown in FIG. 7), (this feature is important because not all tandem axle trailers have the same center to center distance of the wheels 170). The outwardly extending piece 140 includes a lock hole 142.

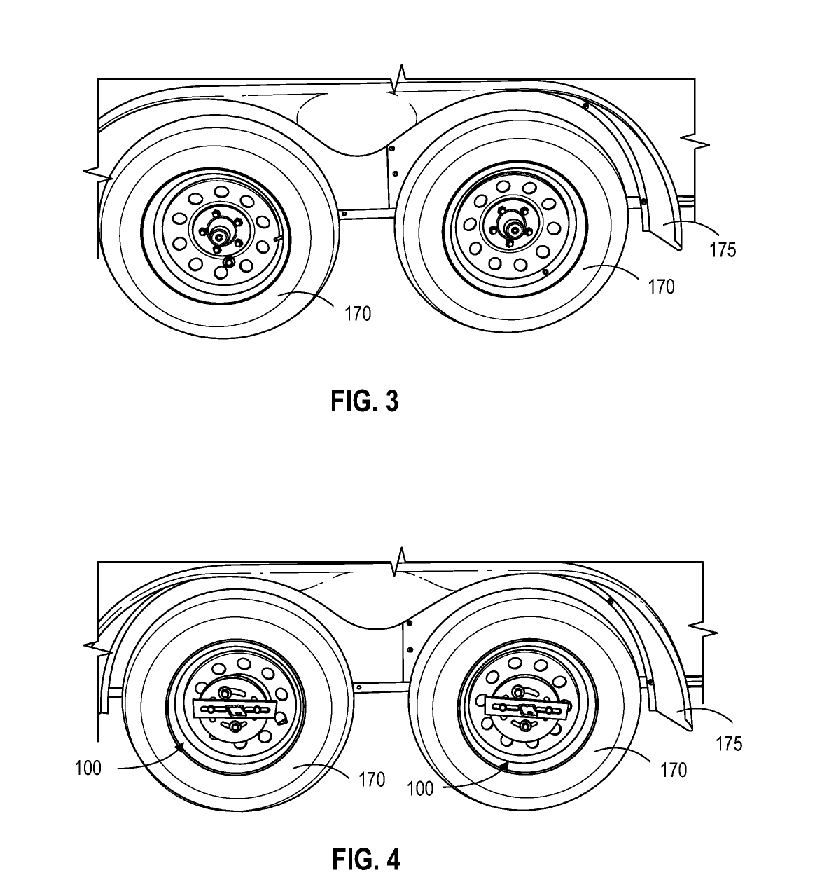

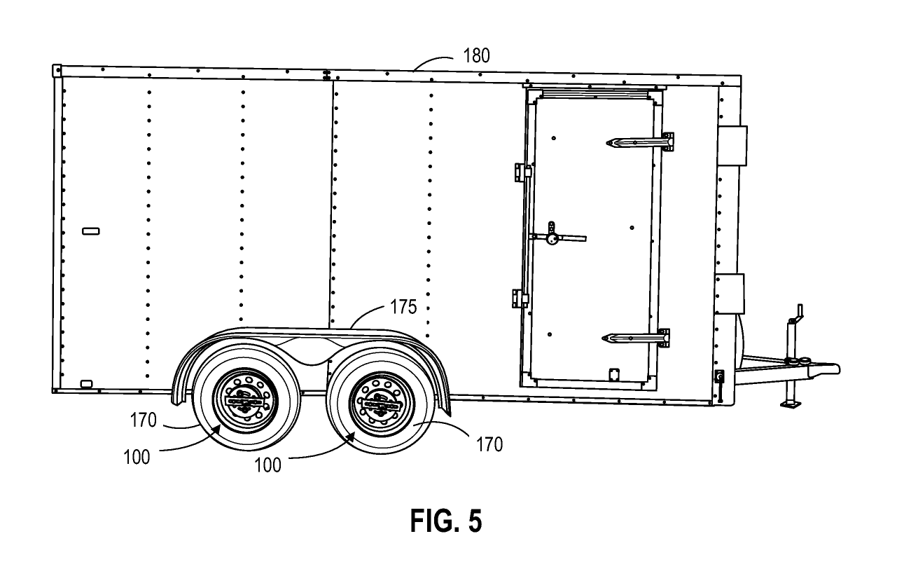

FIG. 3 illustrates two trailer wheels 170 arranged in tandem, the trailer wheels protected by a tandem fender 175. FIG. 4 illustrates wheel attaching devices 100 attached to each of the trailer wheels 170. FIG. 5 illustrates a fuller view of an enclosed utility trailer 180 having the wheel attaching devices 100 attached to the trailer wheels 170. While the device described herein is shown mounted to an enclosed utility trailer 180, it is to be understood that the device could be used for other vehicles, including non-enclosed trailers, horse trailers, boat trailers, recreational trailers and even on certain motor vehicles having tandem wheels.

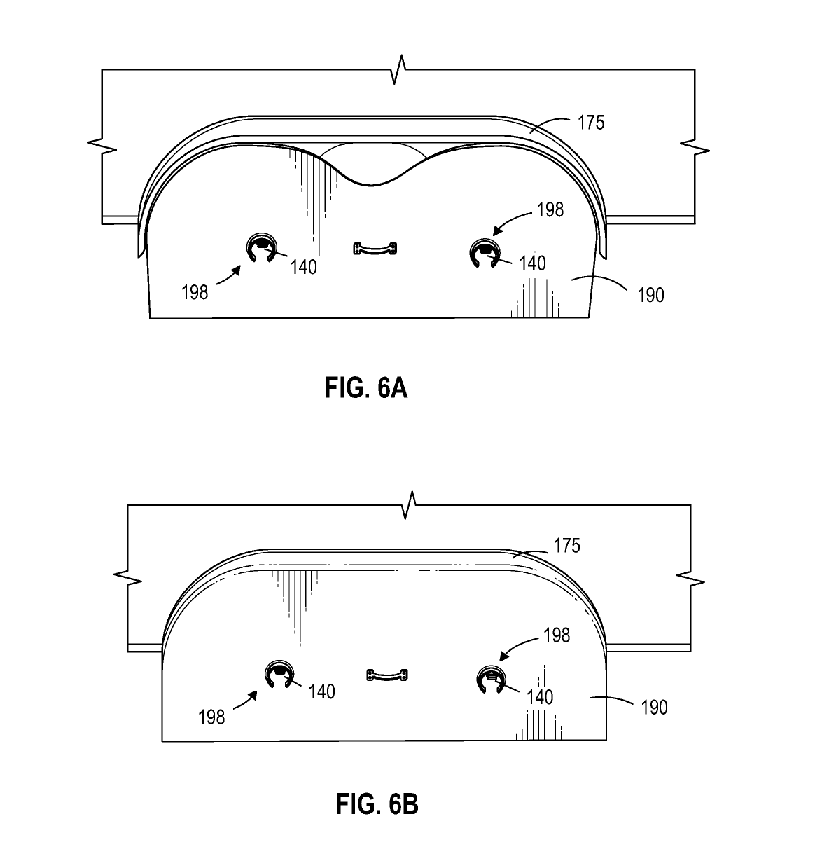

FIG. 6A illustrates an exemplary plate 190 attached under the fender 175, according to an embodiment of the present invention. The plate 190 can be made of a sheet of aluminum or steel. In this embodiment, the plate 190 is a separate piece and slips underneath the fender 175, substantially entirely covering the wheels 170 (which include the tires of the wheels) leaving only the outwardly extending pieces 140 of the wheel attaching devices 100 to protrude. FIG. 6B illustrates an alternate embodiment comprising a plate and fender combination attached to the trailer wheels, where the trailer does not have a fender. In this case, the plate 190 and the fender 175 can be a single piece.

FIG. 7 illustrates a close-up view of the plate 190 highlighting an exemplary opening 197 allowing protrusion of the outwardly extending pieces 140. The plate 190 can include a reinforcement metal strip (not shown) on the inward side of the plate 190 which can be of any thickness depending on the level of security sought and is attached to the plate 190 by welding, an adhesive, or suitable screw or rivet, for example. Surrounding the opening 197 is a lock guard 195 which can be made of a hard material such as steel and attached to the plate by, for example, welding or a suitable adhesive. In other embodiments, the lock guard 195 is made from a single mold. In the illustrated embodiment, a screw 192 is strategically placed behind an area where a lock will be placed, thus making it difficult to remove. When the plate 190 is placed under the fender 175, the protruding portion of the outwardly extending piece 140 will include the lock hole 142. In various other embodiments, the lock guard 195 is not provided.

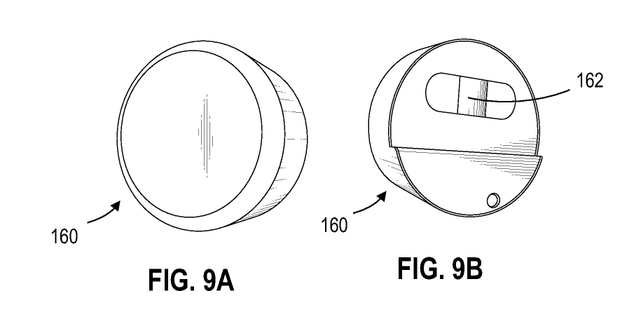

FIG. 8 illustrates an exemplary padlock 160 attached to the outwardly extending piece 140. FIGS. 9 and 10 illustrate front and back views, respectively, of the padlock 160. The bolt 162 of the padlock 160 is placed through the lock hole 142. Once locked, the padlock 160 can only be opened using a key 165. An example of a padlock useable for the padlock 160 is the Master Lock 6270KA Hidden Shackle Padlock, made by Master Lock of Milwaukee Wis. Although a round, hidden shackle padlock (sometimes called a “shackless” padlock) is illustrated herein, it is to be understood that other types of padlocks, such as a padlock without a hidden shackle may suffice, though such a padlock is more easily opened using a bolt cutter. Furthermore, it is to be understood that the padlock 160 can either require a key to open or a be a combination lock.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A wheel locking system, comprising:
a first wheel attaching device mounted to a first wheel; and
a second wheel attaching device mounted to a second wheel;
wherein the first wheel attaching device and the second wheel attaching device are arranged in such a manner that respective axles of the wheels are prevented from rotating.

2. The wheel locking system of claim 1, wherein the first wheel and the second wheel are in tandem and the first wheel attaching device and the second wheel attaching device are disposed on the same side.

3. The wheel locking system of claim 1, wherein the first wheel attaching device and the second wheel attaching device have substantially the same structure.

4. The wheel locking system of claim 3, wherein each of the wheel attaching devices comprises a first portion attachable to at least two lug nuts and a second portion attachable to the first portion and having an outwardly extending piece.

5. The wheel locking system of claim 4, further including a plate covering a fender for the protection of the wheels, including tires of the wheel, the plate including a pair of openings accepting the outwardly extending pieces and allowing end portions of each of the outwardly extending pieces to protrude.

6. The wheel locking system of claim 5, wherein each of the end portions includes a hole.

7. The wheel locking system of claim 6, wherein locks can be secured through the holes.

8. The wheel locking system of claim 1, wherein the first portion is disk shaped and includes a first pair of grooves and a second pair of grooves.

9. The wheel locking system of claim 8, wherein a selected one of the pairs of grooves accommodates wheel fastening bolts and the other one of the pairs of grooves accommodates a fastener attaching the first portion to the second portion.

10. The wheel locking system of claim 9, wherein the pair of grooves accommodating the wheel fastening bolts is capable of accommodating the wheel fastening bolts no matter their orientation.

11. The wheel locking system of claim 8, wherein the grooves are curved and one of the pairs of grooves is positioned closer to the central axis of the wheel it is mounted to than the other one of the pairs of grooves.

12. The wheel locking system of claim 5, wherein the second portion includes a pair of longitudinal grooves, each of the longitudinal groove accommodating a fastener attaching the first portion to the second portion, the longitudinal grooves providing the ability to adjust the attachment of the second portion to the first portion and allowing the outwardly extending piece to align with the pair of openings in the plate.

13. A wheel attaching device, comprising:
a first portion attachable to a wheel; and
a second portion attachable to the first portion and having an outwardly extending piece including a lock attaching hole.

14. The wheel attaching device of claim 13, wherein the first portion is disk shaped and includes a first pair of grooves and a second pair of grooves.

15. The wheel attaching device of claim 14, wherein the first pair of grooves accommodates a fastener useable to secure the first portion to the wheel and the second pair of grooves accommodates a fastener useable to secure the first portion to the second portion.

16. The wheel attaching device of claim 15, wherein the grooves are curved and one of the pairs of grooves is positioned closer to the central axis of the wheel than the other one of the pairs of grooves.

17. The wheel attaching device of claim 15, wherein the second portion includes a pair of longitudinal grooves, each of the longitudinal groove accommodating a fastener attaching the first portion to the second portion.

18. A wheel locking system, comprising:
a first wheel attaching device mountable to a first wheel;
a second wheel attaching device mountable to a second wheel;
a plate, the plate including a pair of openings accepting outwardly extending pieces of each of the wheel attaching devices;
and
a pair of locks, each one of the locks fitting through a hole in a respective wheel attaching device;
wherein, when locked, the first wheel attaching device and the second wheel attaching device are attached in such a manner that respective axles of the wheels are prevented from rotating;
wherein each of the wheel attaching devices comprises a first portion and second portion attachable to the first portion and having the outwardly extending piece; and wherein the first portion includes a first pair of grooves and a second pair of grooves, a selected one of the pairs of grooves capable of accommodating fasteners attached to the wheel upon which it is mounted and the other one of the pairs of grooves capable of accommodating a fastener attaching the first portion to the second portion; and
wherein the second portion includes a pair of longitudinal grooves, each of the longitudinal groove accommodating a fastener attaching the first portion to the second portion.

19. The wheel locking system of claim 18, wherein the plate is attachable to a fender.

20. The wheel locking system of claim 18, wherein the plate is integral with a fender.
